(19) United States
(12) Patent Application Publication
(10) Pub. No.: US 2011/0208469 A1
(43) Pub. Date: Aug. 25, 2011

(54) AUTOMATIC TESTING OF A COMPUTER SOFTWARE SYSTEM

(76) Inventor: Simeon Falk Sheye, Herlev (DK)

(21) Appl. No.: 13/058,097

(22) PCT Filed: May 15, 2009
(86) PCT No.: PCT/EP2009/055927

§ 371 Date: May 10, 2011

(30) Foreign Application Priority Data
May 15, 2008 (EP) PCT/EP2008/055947

(51) Int. Cl. G06F 19/00

(52) U.S. Cl. 702/123

(57) ABSTRACT

The invention relates to a method of automatic testing of a software system through test driver code that classifies test data into equivalence classes and updates the available test data after using it against the software system. One embodiment of the invention is a Test Runner that monitors the effect of calling the software system on the available test data and uses this information to automatically determine the execution order of test cases to meet a number of objectives including to: Reuse data between calls, ensure all test cases are executed, perform parallelized testing, perform time dependent testing, perform continuous testing according to a probability distribution on test cases, perform automated management of complex test data and finally to provide an easy and concise way for a user to define a large sets of test cases.

### FIELD OF THE INVENTION

This invention relates to a method of automatic testing of at least one system under test accessed through at least one interface method defined in a code under test which is accessed via at least one test method defined in a test driver code which is accessed via a test runner; wherein the test runner comprises a list of test conditions, a dependency analysis algorithm and an algorithm for preparing and executing a single test condition. The invention further relates to a device for automatic testing of a first software system, a computer program product and a computer readable medium.

### BACKGROUND OF THE INVENTION

In the field of testing a computer software system using computer software, several methods of testing are known in the art.

A unit test operation comprises three basic steps: A fixture setup step, where the preconditions for the unit test are set up i.e. usually meaning making data for the unit test available and priming a test target for the test; an action step where the action to be tested (e.g. adding a book to a bookstore) is carried out; and a verification step, where the result of the action is verified to match an expectation (e.g. whether the added book can be retrieved using some query).

A data driven test operation is similar to a unit test operation except that the fixture setup step is replaced by a query against a database step that retrieves multiple sets of test data. In the data driven test, the action step and the verification step are executed once for each set of test data retrieved in the query step.

A combinatorial test operation comprising a data driven test where the operation takes multiple parameters:
Operation(param₁, param₂, . . . , paramₙ).

In general in the combinatorial test method, there is a query against a database for each parameter param₁ to paramₙ, in which query separate sets of test data P₁ to Pₙ for each parameter are retrieved. The combinatorial test method then produces the Cartesian product P=P₁×P₂× . . . ×Pₙ and executes the method iteratively with parameters set from (param₁, param₂, . . . , paramₙ)=(p₁, p₂, . . . , pₙ)εP for all tuples in P.

A fixed scenario test operation is typically used for concurrency testing and is structured as a sequence of n steps:
1. Setup: Preparation of test data and priming of a test target.
2. Action₁: Performing the first action against the test target.
3. Verification₁: Verification that the first action gave the expected result.
4. . . . .
5. Actionₙ: The n^{th} action against the test target
6. Verificationₙ: Verification that the n^{th} action gave the expected result

Thus, the fixed scenario test operation is structured as a fixed sequence of actions and accompanying verifications. The setup step can be a fixture setup similar to that from a unit test method; a query like found in the data driven test method or a combinatorial expression like found in the combinatorial test method. A fixed scenario test is commonly used for concurrency testing by executing multiple scenarios simultaneously with different test data in each scenario.

A first problem of the prior art is that the unit test method, for example, does not support data management and does not use e.g. entities and/or properties of the entities. Further, the unit test method does not enable organization of e.g. execution order of the tests.

A second problem of the prior art is that the data driven test method, for example, assumes the existence of a database comprising fixed test data.

A third problem of the prior art is that the combinatorial test method, for example, only enables parameter combinations of data for a plurality of parameters.

A fourth problem of the prior art is that the fixed scenario test method, for example, only executes one or more fixed pre-defined sequences of actions (scenarios).

A fifth problem of the prior art is the retrieving of test data with a direct reference to the test data itself during e.g. combinatorial testing of e.g. a computer software system. Thereby, the prior art does not ensure that (all) relevant combinations of e.g. properties of e.g. entities of the software system have been tested.

A sixth problem of the prior art is the use of the same or very similar data in the tests. For example, in the unit test method the test data is fixed (in the fixture setup) and in the data driven test method, the test data is constrained to the test data present in the database.

A seventh problem of the prior art is the considerable effort required to produce a concurrent test (e.g. tests in which an entity is accessed simultaneously by at least two processes and/or users) and it is difficult and/or impossible to use a non-concurrent test to make a concurrent test due to a limited source of test data.

### SUMMARY OF THE INVENTION

A first object of the invention is to determine a relationship between an equivalence class of a method's parameters and an equivalence class of the method's output. This object of the invention is achieved by a method of automatic testing of at least one system under test accessed through at least one interface method defined in a code under test which is accessed via at least one test method defined in a test driver code which is accessed via a test runner; wherein the test runner comprises a list of test conditions, a dependency analysis algorithm and an algorithm for preparing and executing a single test condition, wherein the method comprises: defining in the test driver code at least one data type defining at least one classification of the data type onto a first finite set of classes (MMCC); defining in the test driver code at least one test method, wherein at least one of the at least one test method requires at least one parameter of the data type, and wherein each of the test methods produces an outcome, which can be classified onto a second finite set of classes, and wherein at least one test method produces at least one output of the data type; defining in the test runner a list of test conditions, wherein each test condition identifies one test method, and for each parameter in the test method, the test condition specifies one equivalence class, and wherein each test condition defines the classification of the test method's outcome onto the second finite set of classes containing at least a success value and a fail value; executing in the test runner a test method according to a test condition, wherein each parameter value in the test method belongs to the equivalence class specified for the parameter in the test condition; during execution of the test method, the test runner records the at least one output from the test method; after execution of the test method, the test runner records the test method's outcome and performs the classification of the test method's outcome onto the second finite set of classes specified in the test condition to produce a value contained in the second finite set of classes; if the value does not indicate a failure, then determining an equivalence class to which the at least one output recorded by the test runner belongs and indexing the at least one output in a first database of the test runner according to the at least one equivalence class to which the output belongs; if the value indicates a success, then determining an equivalence class to which the at least one output recorded by the test runner belongs and recording the equivalence class in an observed output of the test condition.

Further, a second object of the invention is to enable a user to define multiple related test conditions in a concise and simple way, in particular the case where multiple test conditions refer to the same test method, by specifying to the test runner a list of test conditions for each method. A test condition comprises the list of the equivalence classes that the parameter values must belong to, and how the method's outcome must be classified onto at least an OK or FAIL result (the second finite set of classes). Additionally, this method enables a plurality of test conditions to be defined using a single condition generating expression that specifies a set of lists of equivalence classes. Thereby a plurality of test conditions can be defined, with each test condition having a separate list of equivalence classes determining the parameters and a common outcome classification determining the interpretation of the outcome.

Thereby, the invention solves the second, the third, the fifth and the sixth problem of the prior art.

In an embodiment, the method further comprises: Initializing a “current rank” variable to the value 0; storing all test conditions in an enumerable list “UL” containing unranked test conditions and wherein each test condition having its rank reset to a default value; Initializing a “CL” variable capable of containing test conditions; clearing the second database; Repeating until the method terminates: Clearing the CL variable; deleting test conditions identified as enabled from the enumerable list and adding them to the “CL” variable; If the CL variable is empty then marking all test conditions in the UL list as unable to run and terminating the method; assigning the value of the current rank variable to the rank of each test condition in the CL variable; If the UL list is empty then terminating the method; executing any test condition in the CL list which has not had its observed output set; adding all test conditions in the CL list to the second database, indexing each test condition by the rank of the test condition and by each meta-model-equivalence-class in the observed output; incrementing the “current rank” variable by one.

Thereby, the invention achieves a third object; to determine the relationship between test cases such that meta-model-objects emitted as output during execution of earlier test conditions can be used as input for the next test conditions, by specifying a method to determine the relationship between a first test condition's output and a second test condition's parameter values, and to determine the topology of a list of test conditions (defined by each test condition's rank),

Thereby, the invention solves the first problem of the prior art.

In an embodiment, the method further comprises: If a test condition has a rank value of default value then terminating the method; For each test condition initializing the value of InvocationCount1 of the test condition to 0, and initializing the value of InvocationCount2 of the test condition to 0; For each test condition; if the sum of InvocationCount1 and InvocationCount2 is 0 then executing the test condition.

Thereby the invention is able to achieve a fourth object; to execute all test conditions in a list, by in the case where each test condition must be executed a least once, determining if a test condition needs to be executed or not.

In an embodiment, the method comprises: If a test condition has a rank value of default value then terminating the method; If a test condition has a target probability value greater than 1 or less than 0 then terminating the method; If the sum of the target probability value of all test conditions is not 1 then terminating the method; L1: For each test condition initializing the value of InvocationCount1 to 0; and initializing the value of InvocationCount2 to 0. terminating the method if a stopping criterion is satisfied, the stopping criterion comprising one of; a time limit, or an iteration count limit; a first test condition is chosen at random according to the probability distribution; If InvocationCount2 of the first test condition is greater than 0, then decrementing by 1 InvocationCount2 and incrementing by 1 InvocationCount1, else executing the first test condition; the method proceeds from [L1].

Thereby the invention is able to achieve a fifth object; to continuously execute test conditions according to a predefined probability distribution across the list of test conditions by, in the case where test conditions are chosen for execution at random according to some probability distribution, determining if a chosen test condition must be executed or not. A chosen test condition must not be executed if InvocationCount2 is greater than zero because this indicates that the test condition has been executed for other reasons than from being chosen at random.

Thereby, the invention solves the fourth problem of the prior art.

In an embodiment, the executing of a first test condition comprises a second algorithm comprising: if the first test condition has a rank of value less than 0 then terminating the method; If the second database has not been initialized up to a rank value at least one lower than the rank of the first test condition and the first test condition does not have a rank of zero, then terminating the method; If first test condition is not enabled, then terminating the method; Initializing an “ARGS” variable capable of containing a list of meta-model-objects to an empty list; Initializing a “MMEC_UNBOUND” variable capable of containing zero or one meta-model-equivalence-class to contain zero meta-model-equivalence-class, L0: For each meta-model-equivalence-class in the input specification of the first test condition for which there has not been acquired a meta-model-object belonging to the meta-model-equivalence-class, the first database is searched for a meta-model-object belonging to the meta-model-equivalence-class; storing the zero or one resulting meta-model-objects in a “MMO2” variable; if the MMO2 variable is not empty then performing step 6a, else performing step 6b; Step 6a; removing the MMO2 variable from the first database; adding the MMO2 variable to the ARGS variable; Step 6b; adding to the first database all meta-model-objects in the ARGS variable; clearing the ARGS variable, adding the current meta-model-equivalence-class to the MMEC_UNBOUND variable; proceeding to step [L1]; L1: If MMEC_UNBOUND does not contain a MMEC then proceeding to step [L2], else the second database is searched for the test condition of a rank lower than the rank of the first test condition that is keyed by the value of MMEC_UNBOUND resulting in a second test condition; recursively executing the second test condition in the second algorithm wherein the second test condition takes the place of the first test condition; proceeding to step [L0]; L2: executing the test method of the first test condition using the meta-model-objects in the ARGS variable as arguments and collecting test method immediate output and test method checked output values; classifying the test method's outcome into TMEO using the outcome mapping of the first test condition. if TMEO is equal to OK then proceeding to step [L3] else if TMEO is equal to FAIL, then proceeding to step [L4]; L3: creating a new set of meta-model-equivalence-classes and storing the new set of meta-model-equivalence-classes in a new variable OBS; For each meta-model-object in the output, the meta-model-equivalence-class MMEC of the meta-model-object MMO is found and added to the new variable OBS; assigning the new variable OBS to the observed output of the first test condition; storing all meta-model-objects in the first database; continuing from [L5]; L4: clearing output and signaling the test runner that the execution of the first test condition has failed; and terminating the method; L5: If the algorithm has been recursively called from itself then incrementing by one InvocationCount2 of the first test condition, else incrementing by one InvocationCount1 of the first test condition.

Thereby the invention is able to achieve a sixth object; during execution of a first test condition, to reuse as parameter values, meta-model-objects emitted as output or second output during execution of earlier test conditions, or if a meta-model-object belonging to an equivalence class specified by the test condition cannot be found, then to select a second test condition for execution which will provide as output, the meta-model-object that could not be found.

Additionally, the invention is able to achieve a seventh object; parallelization of the execution of test conditions such that multiple test conditions can be executing simultaneously by ensuring exclusive access to all data used as parameter values. This enables a plurality of test conditions to be executed simultaneously without attempting to concurrently access the same data.

Additionally, the invention is able to achieve the fifth object of continuous execution of the test conditions according to a predefined probability distribution across the test conditions, by incrementing either InvocationCount1 or InvocationCount2 depending on whether the algorithm has been recursively called, thus indicating the reason for the execution of the test condition.

Thereby, the invention is able to solve the first, the second, the fourth, and the seventh problems of the prior art.

In an embodiment, the output and/or the second output contains a timestamp indicating a point in time from which the output and/or the second output is valid for use as a parameter value for a test method and wherein the method further comprises; If the “ARDS” variable contains at least one timestamp then delaying the execution of the test method of the first test condition until the time has passed all of the at least one timestamps.

Thereby the invention is able to achieve an eighth object; automatic management of data sets where meta-model objects may depend on time, in particular the case where a meta-model object may not be used before a specific point in time by adding a timestamp to the output from the test method and delaying the execution of the test method according to the timestamp.

In an embodiment, the method further comprises organizing a number of identifiers in a managed object graph stored in a third database, wherein the managed object graph comprises a collection of vertices and directed edges, and wherein a vertex is an identifier and a directed edge is an ordered pair of vertices and wherein a new directed edge is recorded as a third output, when the test method is executed and wherein a deletion of a directed edge is recorded as a fourth output, when the test method is executed; and wherein prior to the execution of the test method, a transitive closure has been computed from the third database using the identifiers of the parameter values as roots for the computation; removing from the first database the meta-model-objects identified by the vertices in the transitive closure; after the execution of the test method and if the value indicates a success, then each third output is added to the third database, and each fourth output is removed from the third database, and if the transitive closure is not empty, each data type instance identified in the transitive closure and reachable from any meta-model object in the first database through the third database is added to the first database.

Thereby the invention is able to achieve a ninth object; automatic management of complex data sets where individual meta-model objects are connected in a managed object graph by managing vertices and directed edges in a managed object graph.

The invention further relates to a device for automatic testing of at least one system under test, wherein the device is adapted to execute the method according an embodiment of the invention.

The device and embodiments thereof correspond to the method and embodiments thereof and have the same advantages for the same reasons.

As mentioned, the invention also relates to a computer readable medium having stored thereon instructions for causing one or more processing units to execute the method according to an embodiment of the present invention.

The computer readable medium and embodiments thereof correspond to the method and embodiments thereof and have the same advantages for the same reasons.

The invention additionally relates to a computer program product comprising program code means adapted to perform the method according to an embodiment of the invention, when said program code means are executed on one or more processing units.

The computer program product and embodiments thereof correspond to the method and embodiments thereof and have the same advantages for the same reasons.

### BRIEF DESCRIPTION OF THE DRAWINGS

FIG. 1 shows a computer software system to be automatically tested by an embodiment.

FIG. 2 shows a device for executing an embodiment or a part of an embodiment.

FIG. 3 shows an embodiment of automatically testing a computer software system, wherein the computer software system to be tested comprises an online bookshop.

FIG. 4 shows an embodiment of automatically testing a first computer software system by a second computer software system.

FIG. 5 shows an embodiment wherein a code under test and system under test belong to the same logical module.

FIG. 6 shows an embodiment wherein the code under test and system under test are detached i.e. belong to separate logical modules.

FIG. 7 shows a test runner executing Test Methods.

FIG. 8 illustrates a number of components contained in a test condition.

FIG. 9 shows the details of a test runner TR executing a test method.

### DETAILED DESCRIPTION OF THE DRAWINGS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the present invention. Thus, the present invention is not limited to the embodiments shown, but is to be accorded the widest scope consistent with the principles and features disclosed herein.

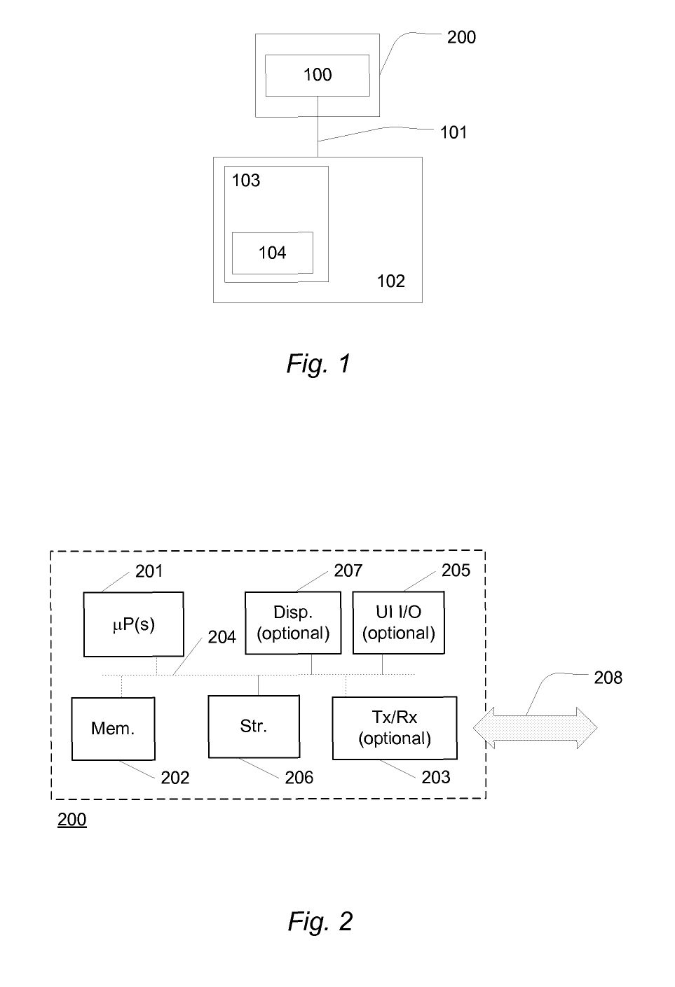

FIG. 1 shows a first computer software system 100. The first computer software system 100 may, for example, be a software application that may be accessed by a second computer system and/or a second computer software system. The first computer software system 100 may, for example, be executed and/or stored on a data processing device 200.

The data processing device 200, shown in FIG. 2, comprises one or more micro-processors 201 connected with a main memory 202 and e.g. a storage device 206 via an internal data/address bus 204 or the like. Additionally, the device 200 may also be connected to or comprise a display 207 and/or communication means 203 for communication with one or more remote systems via one or more wireless and/or wired communication links 208 such as, for example, a Bluetooth communication link, a WLAN communication link, an Infrared communication link, a fiber-optical communication link or the like. The memory 202 and/or storage device 206 are used to store and retrieve the relevant data together with executable computer code for providing the functionality according to the invention. The micro-processor(s) 201 is responsible for generating, handling, processing, calculating, etc. the relevant parameters according to the present invention. The micro-processors 201 may, for example, execute the first computer software system 100. In an embodiment, the micro-processors 201 may execute at least one computer software system such as, for example, a test specification 401 and/or a test application (second computer software system) 419 and/or a first computer software system 402 and/or a third computer software system 410.

The storage device 206 comprises one or more storage devices capable of reading and possibly writing blocks of data, e.g. a DVD, CD, optical disc, PVR, etc. player/recorder and/or a hard disk (IDE, ATA, etc), floppy disk, smart card, PC card, USB storage device, etc.

In an embodiment, the storage device 206 and/or main memory 202 may store at least one computer software system such as, for example, a test specification 401 and/or a test application (second computer software system) 419 and/or a first computer software system 402 and/or a third computer software system 410.

The device 200 may additionally comprise a user interface input/output unit 205 through which a user may interact with the device 200. Examples of user interface input/output units are a computer mouse and a computer keyboard.

The device 200 may thus execute and/or store at least one computer software system such as, for example, a test specification 401 and/or a test application (second computer software system) 419 and/or a first computer software system 402 and/or a third computer software system 410.

The communication means 203 and/or the user input/output unit 205 may provide an interface 101, through which interface 101 the first computer software system 100 may interact with its surroundings 102 such that, for example, data can be inserted and/or queried and/or modified and/or removed from the first computer software system 100 by the surroundings 102.

Alternatively or additionally, a number of actions may be triggered via said interface 101 on said first computer software system 100. An action may, for example be triggered by an entity such as for example a user and/or a second computer software system. A triggered action on the first computer software system 100 may occur immediately when the action is triggered or at some arbitrary later point in time.

Additionally, an action may or may not return a result to the entity triggering it. If a result is returned, the result may, for example, be returned when the action is triggered by an entity and/or when the action occurs on the first computer software system and/or at any arbitrary later point in time. Additionally, triggering one action on the first computer software system 100 may provide zero or more results.

The first computer software system 100 may interact with the surroundings 102 via the interface 101. The interaction may be performed voluntarily and/or spontaneously and/or according to a preset configuration and/or according to one or more external stimuli (e.g. signals and/or commands) from the surroundings 102. The interaction may, for example, be performed by providing the surroundings 102 with data and/or by requesting and/or receiving at least one action from the surroundings 102.

The surroundings 102 may, for example, comprise and/or be connected to a second computer system 103 comprising a second computer software system for automatic testing of the first computer software system 100. The second computer system 103 may, for example, be a device 200 according to FIG. 2. The second computer system 103 may, for example, contain a second computer software system 104 (for example stored in the main memory 202 and/or in the storage device 206 of the second computer system 103), said second computer software system 104 comprising instructions for causing one or more micro-processors 201 of the second computer system 103 to automatically test the first computer software system 100. The test performed by the second computer software system 103 may include a number of test conditions generated by the second computer software system using at least one condition generating expression.

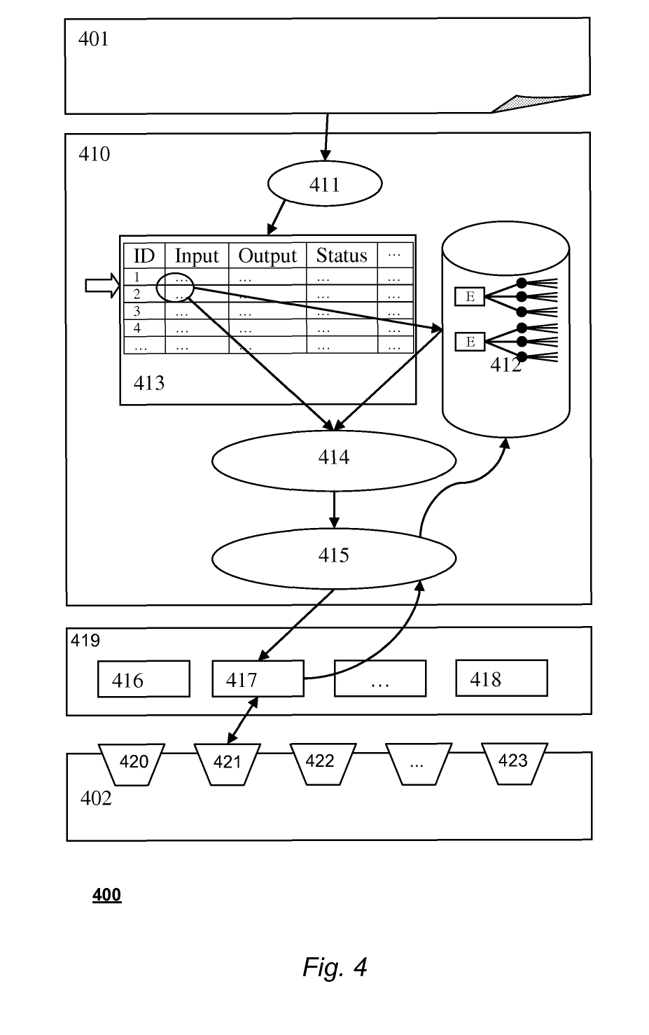

FIG. 4 shows an embodiment of a system 400 for automatic testing of a first computer software system 402 by another computer software system e.g. computer software system 410 and/or 419.

The system 400 may comprise a first computer software system 402 and a third computer software system 410.

The first computer software system 402 may be stored and/or executed on a third data processing device 200 comprising at least one interface 420-423 through which interfaces the first computer software system 402 may interact with, for example, the third computer software system 410. The third computer software system 410 may be stored and/or executed on a fourth data processing device 200. An interface may, for example, contain a wireless and/or a wired communication link 208.

Via the at least one interface 420-423, the third computer software system 410 may, for example, trigger a number of actions, for example one action, on said first computer software system 402. Alternatively or additionally, the third computer software system 410 may monitor the number of actions triggered on said first computer software system 402 via said at least one interlace 420-423. Alternatively or additionally, the third computer software system 410 may monitor a number of events triggered by said number of actions triggered by said third computer software system 410 on said first computer software system 402 via said at least one interface 420-423.

The system 400 may further comprise a second computer software system 419 e.g. a test application 419. The second computer software system 419 may be stored and/or executed on a second data processing device. The test application 419 may comprise a number of operations 416-418, for example one operation. An operation 416-418 may, for example, comprise a prescription to do something i.e. to perform at least one action on the first computer software system 402. The at least one action may, for example, be initiated by the third computer software system 410. The test application 419 may be a second computer software product or a component to a computer software.

The test application 419 may, for example, be connected to the first computer software system 402 via an interface 420-423.

An operation (416-418) may take zero or more parameters, each parameter representing an entity with at least one property. An operation may produce zero or more objects, each object representing an entity with at least one property. An operation may either lead to an outcome e.g. an object or a fault, or it may not terminate.

An outcome may, for example, either be a label, for example the label “A” or empty. A fault may have a complex representation but can be uniquely classified into, for example, a label, for example “B”.

An operation 416-418 may not be required to prescribe anything about the properties its input data may have. Further, an operation may not be required to prescribe anything about whether an action initiated by the operation will succeed or fail. Further, an operation may not be required to describe whether a result shall be considered a success or a failure of the test.

In general, an operation is not guaranteed nor expected always to succeed.

A test application 419 may be produced by a person and/or by a computer software product.

Each of the number of operations 416-418 in the test application 419 may be accessible by the third computer software system 410. For example, the second computer software system 419 may be loaded into the third computer software system 410. The third computer software system 410 may, for example, load the test application 419 via an interface 208 and/or via a user input/output unit 205. Alternatively or additionally, the test application 419 may be part of the third computer software system 410.

Additionally, the system 400 may comprise a test specification 401. In order to make a thorough test of a first computer software system 402, all or substantially all (e.g. 85% of all) combinations of properties of data passed to the operations 416-418 should be tested.

The test specification 401 may be stored and/or executed on a first data processing device 200.

The test specification 401 may contain a number of test condition specifications such as for example one test condition specification. A test condition specification may be a mechanism for specifying the conditions under which an operation can be performed and what result to expect from the operation.

A test condition specification may comprise a number of condition generating expressions, for example one, and a number of outcome specifications, for example one, and a number of fault specifications, for example one.

A condition generating expression may be a mechanism, for example a mathematical expression, for generating a number of criteria, for example one, that may be satisfied by the parameters of an operation. A criterion can define at least one property for each parameter of an operation. If the condition generating expression generates a plurality of criteria, each criterion of the plurality of criteria generates at least one test condition.

A test condition may define a criterion for an operation's parameters and may further define an expected outcome.

An outcome specification determines for an outcome:
Whether the outcome is regarded a “success” or a “failure”
Whether multiple invocations of an operation associated with the outcome, invoked with parameters satisfying a first criterion, yield objects that satisfy a second criterion.
Whether the outcome is used for dependency analysis.

A fault specification transforms a number of faults, for example one fault, into an outcome.

A parameter may be characterized as specifiable, if there exists a generator which, given a criterion, can produce an object which satisfies said given criterion.

A parameter may be characterized as consumed if the parameter is removed from a database after being operated by an operation.

A parameter may be characterized as non-consumed if the parameter remains in the database after being operated by an operation.

A rank-0 test condition is a condition where the operation either does not take any parameters at all, or where it is trivial to acquire parameters that satisfy the criterion of the test condition.

A parameter may be trivial to acquire if the parameter is specifiable and/or non-consumable.

Before or as part of executing a number of test conditions, e.g. a set of test conditions comprising three test conditions, the test conditions may be analyzed for dependencies to determine how to fit together a plurality of test conditions such that objects yielded by the execution of one test condition can be used as parameters for other test conditions. The analysis is implemented by the algorithm below which may, for example, be contained in the third computer software system and thus executed and/or stored on the fourth device:

### Algorithm 1—Dependency Analysis

The goal of this algorithm is to record enough information about the set of test conditions regarding what outcome and objects each test condition in the set of test conditions produce and what properties the produced objects have, such that for every test condition in the set of test conditions it becomes possible to produce an arguments required to execute the test condition, or it becomes clear that such arguments cannot reliably be produced.

### Preconditions

a. all test conditions in the set of test conditions are made available in a set such as for example an enumerable list;
b. Identifying all rank-0 test conditions in the set of test conditions;
c. Marking all test conditions as “not executed”, for example by clearing a first flag;
d. Defining a rank comprising a pair of data-structures, a first data-structure comprising a number, e.g. a counter, and a second data-structure comprising a first set of the set of test conditions.

### Algorithm

1. A first rank is constructed comprising a first data-structure assigned to the value zero and a second data-structure assigned all rank-0 test conditions.
2. All test conditions in the current rank are executed by the third computer software system 410 and for every test condition executed using algorithm 2 below, the third computer software system 410 records what the outcome was, and for every object yielded by the test condition it is recorded which criteria that object satisfies. The first flag is set for each executed test condition.
3. An additional rank is constructed comprising a first data-structure assigned to the value of the first data-structure of the first rank incremented by one and a second data structure is assigned a new set of test conditions comprising the test conditions that have not yet been executed (having a cleared first flag) but which can be executed using parameters that are trivial to acquire or parameters available as objects yielded by the execution of test conditions of lower rank.
4. The process is repeated from step 2 as long as the second data structure assigned to the additional rank in step 3 contains a non-empty set of test conditions.

The result of the dependency analysis can be used to guide the execution of the set of test conditions using the following algorithm that determines how a test condition can have data generated for its input parameters before the test condition is executed. The algorithm below may, for example, be contained in the third computer software system and thus executed and/or stored on the fourth device:

### Algorithm 2—Execution of a Test Condition

The goal of this algorithm is to prepare arguments satisfying the criteria of a first test condition to use with the operation of the first test condition. Arguments are either acquired from a database 412 of the fourth device, which database 412 comprises pre-existing objects or objects generated by executing other test conditions, which other test conditions yield objects that can be used as arguments.

### Preconditions

a. A database 412 of objects organized such that the database 412 can be searched by object type and/or by the properties that comprise the parameter criteria of the test conditions in the set of test conditions and/or directly by parameter criteria.
b. The first test condition to be executed, takes n parameters
c. The first test condition to be executed has been analyzed by the third software system 410 and assigned a value r in the first data-structure using the algorithm 1.
d. The first test condition contains two counters c1 and c2.

### Algorithm

1. A parameter count p is set to 0 by the third software system 410.
2. If p=n the algorithm proceeds to execution of the first test condition in step 5 below.
3. If the database 412 contains an object matching the type and criterion for parameter number p in the first test condition then that object is bound to parameter p, and the parameter count p is incremented and the algorithm continues from step 2 above.
4. The test conditions that have been analyzed by the third software system 410 in the dependency analysis and have been assigned a rank less than r in their respective first data-structures are searched for second test conditions yielding an object that matches the type and criteria for parameter number p. The result of this search is denoted result R.
If the result R is empty, then the first test condition is marked “unable to run” and the algorithm terminates.
Otherwise, a second test condition in the result R is chosen according to a selection criterion, for example the second test condition may be chosen by random from the result R, and the second test condition is then executed according to this algorithm (algorithm 2) by the third software system 410. Subsequently, the algorithm proceeds from step 2.

### Execution of a Test Condition

5. The first test condition is executed, marked “executed” and the objects yielded by the execution are stored in the database 412.
   a. If a fault is encountered, the number of fault specifications is searched for a specification that can transform the current fault to an outcome. If no specification is found, the first test condition is marked “Failed”, otherwise the first matching fault specification is used to determine the outcome.
   b. If the outcome specification states that the observed outcome is a “failure”, the first test condition is marked failed.
   c. If the outcome specification states that multiple invocations of the first test condition (i.e. the associated operation, with parameters satisfying the criteria stated in the first test condition) must yield objects that satisfy identical criteria, and if there has been a prior execution of the first test condition, then the objects yielded by the current execution are compared to the objects yielded by the previous execution to verify that both sets of objects satisfy the same criteria. If they do not satisfy the same criteria the first test condition is marked “failed”.
   d. If the first test condition is not marked “failed”, the first test condition is marked “success”.
      i. If algorithm 2 has been recursively invoked by algorithm 2 the counter c2 of the first test condition is incremented by 1. Otherwise the counter c1 is incremented by 1. The purpose of c1 is to count the invocations that result from e.g. algorithm 4 step 2. The purpose of c2 is to count the invocations that result from e.g. algorithm 2 step 4. The purpose of algorithm 4 step 3 is to adjust the actually obtained frequency distribution of invocations to approach the probability distribution set in algorithm 4 precondition b.

Execution of test conditions may happen in parallel (i.e. concurrently) by executing one instance of algorithm 2 for each parallel invocation of a test condition.

There are a plurality of methods to select test conditions and schedule them for execution, for example, “Every Condition Once” and “Statistical Scenario”.

### Algorithm 3—Every Test Condition Once

The goal of this algorithm is to execute every test condition at least once. The algorithm below may, for example, be contained in the third computer software system and thus executed and/or stored on the fourth device:

### Preconditions

a. A list of test conditions which have been selected for execution, the list may be enumerable.
b. All selected test condition are marked “not executed”. For example, the third computer program 410 may clear the first flag of each fo the selected test conditions.
c. The set of test conditions has been analyzed according to Algorithm 1 by the third computer system 410.

### Algorithm

1. For each test condition in the list of conditions, if the condition is marked “not executed” the condition is executed using algorithm 2.

### Algorithm 4—Statistical Scenario

The goal of this algorithm is to keep executing a plurality of test conditions according to a probability distribution until some stopping criteria is satisfied. When the algorithm terminates, the sum of c1 and c2 for each test condition in the plurality of test conditions is the number of times each respective test condition has been executed.

The algorithm below may, for example, be contained in the third computer software system and thus executed and/or stored on the fourth device:

### Preconditions

Pa: A list of test conditions which have been selected for execution,
Pb: Each selected test condition has been assigned a probability between 0 and 1 and the sum of all probabilities sum to 1.
Pc: All test conditions are assigned two counters, c1 and c2 both initialized to 0.

### Algorithm

1. If the stopping criterion, for example a time limit or an iteration count limit, is satisfied, the algorithm terminates.
2. A first test condition Tc is chosen at random according to the probability distribution.
3. If the counter c2 of the first test condition Tc is greater than 0, c2 is decremented by 1 and c1 of the first test condition Tc is incremented by 1. Otherwise, the first test condition Tc is executed using algorithm 2.
4. The process is repeated from step 1.

The test specification 401 may be a computer software product or a computer software component. A test specification 401 may be produced by a person and/or by a computer software product. The test specification 401 may be stored and/or executed on a device according to FIG. 2, for example a first data processing device 200.

The test specification and/or any number of the number of condition generating expressions contained in the test specification 401 may be loaded by the third computer software system 410 via, for example, an interface 208 and/or via a user input/output unit 205.

In an embodiment, the third computer software system 410 loads the test application 419 or a part of it (e.g. three operations) and the test specification 401 or a part of if (e.g. three condition generating expressions) via an interface 208 and/or via a user input/output unit 205. The test application 419 and the test specification 401 may be stored in the memory 202 and/or storage device 206 of the second computer system 103 executing and storing said third computer software system 410.

During execution, the third computer software system 410 may generate a number of test conditions 413, e.g. two test conditions, based on said test specification 401. The number of test conditions may, for example, be generated by a parser 411 parsing the test specification 401. Each test condition 413 may comprise at least one specification of an operation 416-418 i.e. at least one specification of properties required by at least one input to said operation 416-418 and how the operation 416-418 is expected to respond to the at least one input.

The third computer software system 410 may comprise a database 412 comprising a number of entities, such as for example two entities. An entity may be an item handled by the first computer software system 402, for example, a book, a car, etc.

The database 412 may be indexed by a first index indexing the entities serving as an input to the operations 416-418 and/or by a second index indexing the properties of the one or more entities used in the test specification 401. The database 412 may be contained in the memory 202 and/or the storage device 206 of the fourth data processing device.

When the third computer software system 410 loads the test specification 401, the third computer software system 410 prepares the first and second indexes of the database 412.

In order to test the first computer software system 402, the third computer software system 410 may, for example via plan generator 414, select a first test condition to execute from the number of test conditions 413.

The first test condition may specify a number of properties required to an input to an operation and how the operation 416-418 is expected to respond to the input. The plan generator 414 in the third computer software system 410 may query the database 412 for information on which entities in the database fulfill the specified properties of the required input. The plan generator 414 may, for example, quire the database via the first and/or the second indexes.

If a required first input to an operation may not be found in the database, the plan generator 414 may search the number of test conditions for a second test condition, which second test condition may produce said required first input.

If no second test condition is found in the database, the first test condition may be marked with a flag, said flag indicating that the first test condition is unable to be executed.

Otherwise, if a second test condition is found, the third computer software system 410 may query the database 412 for information on which entities in the database fulfill the specified properties of the required input to the second test condition. If a required first input to an operation may not be found in the database, the plan generator 414 of the third computer software system 410 may search the number of test conditions for a third test condition, which third test condition may produce said required first input etc.

When all required input is found, the plan generator 414 may invoke an operation 416-418 associated with the first test condition via an invoker 415 of the third computer software system 410.

During invocation of the operation 416-418 by the invoker 415, the operations may generate and monitor a number of actions on the first computer software system 402, for example two actions. All data transmitted from and received by the by the operation are collected by the invoker 415 and stored in the database 412.

In an embodiment, the test specification 401 may be stored and/or executed on a first data processing device 200 as shown in FIG. 2 and the test application (second computer software system) 419 may be stored and/or executed on a second data processing device 200 as shown in FIG. 2. In this embodiment, the first and third computer software systems 402 and 410 may be stored and/or executed on third and fourth data processing devices 200 as shown in FIG. 2, respectively.

In an embodiment, the test specification 401 may be contained in the test application (second computer software system) 419, which test application may be stored and/or executed on a second data processing device 200 as shown in FIG. 2. In this embodiment, the first and third computer software systems 402 and 410 may be stored and/or executed on third and fourth data processing devices 200 as shown in FIG. 2, respectively.

In an embodiment, a first part of the test specification 401 may be stored and/or executed on a first data processing device 200 as shown in FIG. 2 and a second part of the test specification 401 may be contained in the test application (second computer software system) 419, which test application may be stored and/or executed on a second data processing device 200 as shown in FIG. 2.

The test specification 401 may, for example, comprise a plurality of test condition specifications, such as four test condition specifications. The first part of the test specification 401 may, for example, comprise at least one test condition specification, such as one test condition specification. The second part of the test specification 401 may, for example, comprise at least one test condition specification, such as three test condition specifications.

In this embodiment, the first and third computer software systems 402 and 410 may be stored and/or executed on third and fourth data processing devices 200 as shown in FIG. 2, respectively.

In an embodiment, the test specification 401 may be stored and/or executed on a first data processing device 200 as shown in FIG. 2. The test application (second computer software system) 419 may be contained in the first computer software system 402, which first computer software system 402 may be stored and/or executed on a third data processing device 200 as shown in FIG. 2.

In this embodiment, the third computer software systems 410 may be stored and/or executed on a fourth data processing device 200 as shown in FIG. 2.

In an embodiment, the test specification 401 may be contained in the test application (second computer software system) 419 and additionally, the test application (second computer software system) 419 may be contained in the first computer software system 402, which first computer software system 402 may be stored and/or executed on a third data processing device 200 as shown in FIG. 2.

In this embodiment, the third computer software systems 410 may be stored and/or executed on a fourth data processing device 200 as shown in FIG. 2.

In an embodiment, a first part of the test specification 401 may be stored and/or executed on a first data processing device 200 as shown in FIG. 2 and a second part of the test specification 401 may be contained in the test application (second computer software system) 419, and additionally, the test application (second computer software system) 419 may be contained in the first computer software system 402, which first computer software system 402 may be stored and/or executed on a third data processing device 200 as shown in FIG. 2.

In this embodiment, the third computer software systems 410 may be stored and/or executed on a fourth data processing device 200 as shown in FIG. 2.

In an embodiment, the test specification 401 may be stored and/or executed on a first data processing device 200 as shown in FIG. 2. The test application (second computer software system) 419 may be contained in the first computer software system 402, which first computer software system 402 may be contained in the third computer software system 410, which third computer software system 410 may be stored and/or executed on a fourth data processing device 200 as shown in FIG. 2.

In an embodiment, the test specification 401 may be contained in the test application (second computer software system) 419. The test application 419 may be contained in the first computer software system 402. The first computer software system 402 may be contained in the third computer software system 410, which third computer software system 410 may be stored and/or executed on a fourth data processing device 200 as shown in FIG. 2.

In an embodiment, a first part of the test specification 401 may be stored and/or executed on a first data processing device 200 as shown in FIG. 2 and a second part of the test specification 401 may be contained in the test application (second computer software system) 419. The test application 419 may be contained in the first computer software system 402. The first computer software system 402 may be contained in the third computer software system 410, which third computer software system 410 may be stored and/or executed on a fourth data processing device 200 as shown in FIG. 2.

In an embodiment, the test specification 401 may be stored and/or executed on a first data processing device 200 as shown in FIG. 2. The test application 419 may be contained in the third computer software system 410, which third computer software system 410 may be stored and/or executed on a fourth data processing device 200 as shown in FIG. 2.

In this embodiment, the first computer software system 402 may be stored and/or executed on a third data processing device 200 as shown in FIG. 2.

In an embodiment, the test specification 401 may be contained in the test application (second computer software system) 419. The test application 419 may be contained in the third computer software system 410, which third computer software system 410 may be stored and/or executed on a fourth data processing device 200 as shown in FIG. 2.

In this embodiment, the first computer software system 402 may be stored and/or executed on a third data processing device 200 as shown in FIG. 2.

In an embodiment, a first part of the test specification 401 may be stored and/or executed on a first data processing device 200 as shown in FIG. 2 and a second part of the test specification 401 may be contained in the test application (second computer software system) 419. The test application 419 may be contained in the third computer software system 410, which third computer software system 410 may be stored and/or executed on a fourth data processing device 200 as shown in FIG. 2.

In this embodiment, the first computer software system 402 may be stored and/or executed on a third data processing device 200 as shown in FIG. 2.

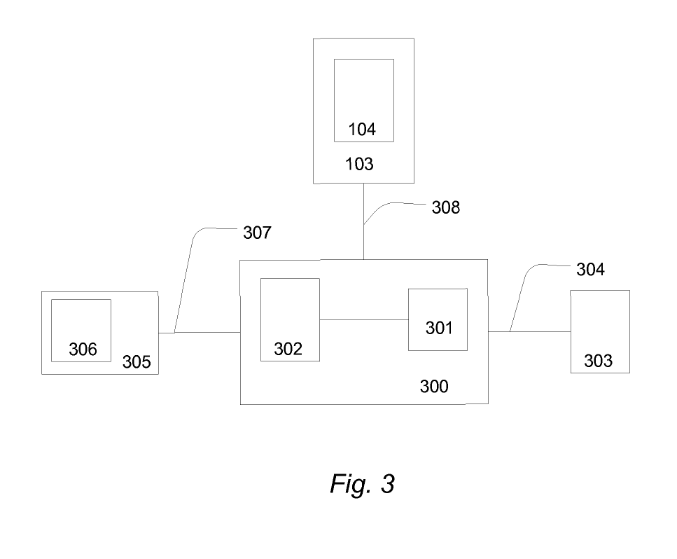

FIG. 3 shows an embodiment in which the computer software system to be tested is an online bookshop 300.

In FIG. 3, an embodiment is shown in which the first computer software system 100 contains an online bookshop 300 which is to be automatically tested by a second computer software system 104. The online bookshop 300 may, for example, be hosted on a device 200 according to FIG. 2.

The online bookshop 300 may, for example, comprise:
A book 301 which can be added to the online bookshop 300. For example, an added book 301 may be displayed on a homepage 302 of the online bookshop 300. Thereby, the added book 301 can be purchased in the online bookshop 300, for example by a customer device 303 visiting the online bookshop 300 via the homepage 302. The customer device 303 may, for example be a device 200 according to FIG. 2. The customer device 303 may, for example, be connected to the online bookshop 300 e.g. via a network 304 such as the Internet and/or any other type of network such as LAN, WAN, Bluetooth, etc. enabling the customer device 303 to interact with the online bookshop 300.
A stock 305 comprising a number of books. For example, the stock 305 may comprise a number of added books and/or a number of books not added to the online bookstore 300. The stock 305 may, for example, comprise a stock computer 306. The stock computer 306 may, for example, be a device 200 according to FIG. 2. The stock computer 306 may interface with the online bookshop e.g. via a network 307 such as, for example, the Internet and/or a LAN and/or a WAN, etc. The interfacing between the online bookshop 300 and the stock computer 306 may, for example, provide the homepage 302 with information regarding which books are on stock and which books that are not on stock. The stock 305 can be replenished so there will be books for a customer device 303 to receive e.g. after a purchase from the online bookshop 300. In an embodiment, books to be replenished require to be on a list in the online bookshop.
A book 301 may comprise a price, and the price of a book can be changed. Further, a book 301 may comprise an ISBN number and/or an author and/or a title and/or a category.
A customer can via a customer device 303 search a number of books in the online bookshop 300, for example, a customer may search all books in the online bookshop 300 e.g. via the homepage 302. The search may, for example, be performed using ISBN and/or author and/or title and/or category. All books 301 in the online bookshop may comprise an ISBN. However, a number of books 301 may not have e.g. an author (e.g. the Bible). Further, a number of books 301 may not comprise a title (e.g. a book not yet available).
A customer accessing the online bookshop homepage 302 e.g. via the customer device 303 may be associated with an electronic shopping cart on the homepage 302. The customer may add any number of books to the electronic shopping cart (e.g. any positive number or zero copies of any number of books 301 which have been added to the online bookstore 300).
If a customer decides to pay e.g. via the customer device 303, a number of books may be unavailable in the stock 305. In that case the customer may be given a choice to pay up front and receive the number of books not in stock when they become available or to reserve the number of books not in stock without paying and receiving a notification via email when the books not in stock become available. A notification may, for example, require a response from the customer by e.g. an order confirmation from the customer. The customer response may, for example, be required within a set time interval, otherwise the reservation may be cancelled.

To automatically test the online bookshop 300, a second computer software system such as a test software product 104 for automatic testing may be utilized. The test software product may be contained in a second computer system 103 and may, for example, be connected to the online bookshop 300 (for example to the homepage 302). The second computer system 103 may be connected to the online bookstore 300 for example via a network 308 such as for example the Internet and/or any other type of network such as LAN, WAN, Bluetooth, etc.

The test software product 104 may, for example, require knowledge of a number of entities of the online bookshop 300. For example, the test software product 104 may require knowledge of all entities in the online bookshop 300.

An entity of the online bookshop may, for example, be a book 301 and/or a price of a book and/or the stock 305 and/or an electronic shopping cart and/or a reservation of a book by a customer and/or a notification to a customer regarding availability of a reserved book etc.

Each entity may comprise a number of properties. A property of a book 301 may, for example, be whether the book has an ISBN number or not. Alternatively or additionally, a property of a book 301 may be whether or not the book has a price and/or an author a price and/or a title and/or a category. A further property of a book 301 may, for example, be whether the book 301 is in the stock 305. Alternatively or additionally, a property of a book 301 may be whether the book 301 is enlisted on the homepage 302 of the online bookshop 300.

Similarly one or more of the other entities (e.g. the price of a book and/or the stock 305 and/or the electronic shopping cart and/or the reservation of a book by a customer and/or the notification to a customer regarding availability of a reserved book) of the online bookshop 301 may comprise a number of properties.

The test software product 104 may comprise a number of operations. An operation may, for example, consume one or more entities of the online bookshop 300. Alternatively or additionally, an operation may produce one or more entities on the online bookshop 300 e.g. as a result of the operation.

For example, the test software product 104 may comprise an operation of adding a book 301 to the online bookshop 300. Thereby, the operation may consume one book 301 and attempt to add the book 301 to the online bookshop 300. If the operation is successful, the book 301 may subsequently be marked as “in the online bookstore” wherein the mark, for example, may be a property of the book 301. Subsequently, the book 301 may be returned to the test software product 104 for example in order to be re-indexed according to its changed properties (i.e. that the book 301 is now available in the online bookstore 300).

In general, an operation is not guaranteed nor expected always to succeed: if, for example, a valid book, i.e. a book 301 comprising an ISBN number and which is not marked as being added to the homepage 302, is subjected to the abovementioned operation of adding a book to the homepage, then the operation may be expected to succeed. A failure to succeed may be considered as a test error i.e. as an error of the computer program system 100 e.g. an error in the online bookstore 300.

If, for example, a book without ISBN and/or a book being marked as being added to the online bookstore 300 is attempted added to the online bookstore 300, the operation of adding a book to the online bookstore may be expected to fail. If the operation of adding a book to the online bookstore 300 does not fail in such an example, then it may be considered as a test error i.e. as an error of the computer program system 100 e.g. an error in the online bookstore 300.

In general, an operation may be a prescription to do something i.e. to perform at least one action on the computer software system 100 by the test software product 104 and/or the means 103 for automatic testing.

An operation may not be required to prescribe anything about the properties its input data may have. Further, an operation may not be required to prescribe anything about whether an action will succeed or fail. Further, an operation may not be required to describe whether a result shall be considered a success or a failure of the test.

The test software product 104 may further comprise a number of test conditions. A test condition may comprise a specification of what properties data to be passed to an operation may be required to have. Additionally, a test condition may determine how an operation may be expected to react with the data (e.g. success or failure).

For example, an operation testing whether a book can be added to the online bookstore 300 may be comprised in a test condition stating that:
The book may not already be on the homepage 302;
the book may have an ISBN number; and
the operation may be expected to succeed in adding the book.

A complete list of test conditions may be contained in a test specification.

The test software product 104 may further comprise a number of condition generating expressions. A condition generating expression may be a mechanism for providing a number of test conditions.

Additionally or alternatively, a condition generating expression may comprise a set of expressions in at least one property of at least one input parameter (e.g. an entity) to an operation. A number of conditions (e.g. all conditions) generated by a condition generating expression may be expected to lead to the same result e.g. a success and/or a failure and/or a specific failure of more than one type of failure of the operation.

For example, in order to make a thorough test of adding a book 301 to the online bookstore 300, the test software product 104 may test all relevant combinations of book properties, such as, for example, the combinations of whether the book has a title and/or an author and/or a category.

In general, a condition generating expression may be a concise way of specifying a number of test conditions (e.g. at least two test conditions).

Thus, in an embodiment, the test software product 104 may comprise and/or utilize and/or involve one or more of the following:
Entities—Items handled by the computer program system 100 being tested by the test software product such as for example books and/or prices and/or shopping carts etc.
Properties—of the entities such as, for example, a Boolean variable indicating whether e.g. a book 301 has an author and/or whether a book 301 has a title and/or whether a book 301 is presented on the homepage 302 of the online bookshop 300, etc.
Operations—which may perform a number of actions on the computer program system 100 being tested, such as for example adding a book to the homepage 302, replenishing the stock 305, querying a customer whether the customer would like to pay in advance or reserve a book, responding to a notification from a customer, etc.
An operation may, for example:
   1. Accept zero or more entities as input.
   2. Perform at least one action on the computer program system 100 under test using the entities.
   3. Verify the result of the at least one action performed on computer program system 100 under test.
   4. Return a number of entities input into the operation to the test software product 104.
Condition generating expressions—specifying a number of test conditions under which the operations may be invoked during the test of the computer program system 100.

In general, the test software product 104 may be responsible for managing a number of entities and executing a number of test conditions and managing the execution order of a number of test conditions and managing the number of times each test condition is executed such that data becomes available to execute all possible conditions in the test.

A test author, e.g. a person supervising the test software product 104, or a software product may define a number of operations and/or defining the condition generating expressions.

In an embodiment, Backus-Naur-Form (BNF) may be utilized as syntax in order to specify a number of test conditions e.g. a list of test conditions i.e. BNF may be used as a condition generating expression.

For example, a list of test conditions may be generated using a BNF specified condition generating expression:

TABLE 10
Example of BNF for a condition generating
expression language.

| | |
|---|---|
| EXPR | ::= EXPR OP EXPR \| (EXPR) \| TUPLE \| SET \| |
| | parameter_name.EXPR_PA \| parameter_name. |
| | property_name.EXPR_PR |
| EXPR_PA | ::= EXPR_PA op EXPR_PA \| (EXPR_PA) \| TUPLE_PA \| |
| | SET_PA \| property_name.EXPR_PR |
| EXPR_PR | ::= EXPR_PR op EXPR_PR \| (EXPR_PR) \| TUPLE_PR \| |
| | SET_PR |
| OP | ::= + \| − \| * |
| SET | ::= {TUPLE_comma_separated_list} \| |
| | {VALUE_comma_separated_list} \| {!VALUE} \| {*} |
| SET_PA | ::= {TUPLE_PA comma_separated list}\| |
| | {VALUE_PA comma_separated_list} \| {!VALUE_PA} \| {*} |
| SET_PR | ::= {TUPLE_PR comma_separated_list} \| |
| | {VALUE_PR_comma_separated_list} \| {!VALUE_PR} \| {*} |
| TUPLE | ::= [VALUE_comma_separated_list] |
| TUPLE_PA | ::= [VALUE_PA_comma_separated_list] |
| TUPLE_PR | ::= [VALUE_PR_comma_separated_list] |
| VALUE | ::= parameter_name.property_name.value_name |
| VALUE_PA | ::= property_name.value_name |
| VALUE_PR | ::= value_name |

The terminals in this syntax are value_name, property_name, parameter_name.

parameter_name may be a name representing a parameter of an operation.

property_name may be a name representing a property of the parameter identified by the closest preceding parameter_name.

value_name may be a name representing a value of the property identified by the closest preceding property_name.

The use of the suffix “_comma_separated_list” after a non-terminal means that the non-terminal can be repeated zero or more times with a comma (“,”) separating each repetition.

Alternatively, any syntax or meta-syntax may be used to specify a number of condition generating expressions. An example of an alternative meta-syntax is Extended BNF.

In the above and below, the following definitions apply:
SUT (System under Test; 523, 631, 740): The system that is being tested through its interface by calling its Ns using MOs as arguments.
IM (Interface Method; 522, 622, 731): A method, also known as a function that interacts with the SUT. A common example of an IM is a web service operation (e.g. defined in WSDL (Web Service Definition Language)) that is given a client-side representation in the form of a method implemented in e.g. the Java or C# language.
MC (Model Class; 521, 621): A data structure used directly or indirectly by an IM. A common example is a data type declared in XSD (XML Schema Definition) and implemented as a class in e.g. the Java or C# language.
MO (Model Object): An instance of a MC. The MC defines the layout of data while the MO realises a specific set of values according to the MC layout.
MMC (Meta-Model Class; 511, 611): A user-defined class (a composite data type) that aggregates 0 or more MC items and defines one or more MMCCs or a MC that defines one or more MMCCs. There are four main subtypes of MMCs and the combinations thereof:
   MMC-Plain: A MMC where instantiated MMOs are consumed when used with a TM.

TABLE 1
C# example of MMC-Plain

```
public class MMC_Plain
{
  public enum MMCV_list { A, B, C }
  public MC1 Mol;
  public bool MMCC1 { get; }
  public MMCV_list MMCC2 { get; }
}
```

MMC-Settable: A MMC that can be instantiated into a MMO without additional data (in C# and Java this is equivalent of a class having a public default constructor) and where the MMEC can be directly set by setting each MMCC of the MMO to a specific MMCCV (in C# or Java each MMCC can be represented by a settable property).

TABLE 2
C# example of MMC-Settable

```
[Settable]
public class MMC_Settable
{
  public enum MMCV_list { A, B, C }
  public bool MMCC1 { get; set; }
  public MMCV_list MMCC2 { get; set; }
}
```

MMC-Identifiable: A MMC where each instantiated MMO can be uniquely distinguished, e.g. by having a unique identifier, for example a Universally Unique Identifier (UUID).

TABLE 3
C# example of MMC-Identifiable

```
public class MMC Identifiable : IIdentifiable
{
  public MMC_Identifiable( ) { }
  public MC2 Mo2;
  public bool MMCC1 { get; set; }
  public MMCV_list MMCC2 { get; set; }
  public enum MMCV_list { A, B, C }
  public System.Guid Id { get { return id; } }
  private System.Guid id = Guid.NewGuid( );
}
```

MMC-Singleton: A MMC where an instantiated MMO is not consumed when used with a TM.

TABLE 4
C# example of MMC-Singleton

```
[Singleton]
public class MMC_Singleton
  {
  public MC3 Mo3;
  public bool MMCC1 { get; set; }
  public MMCV_list MMCC2 { get; set; }
  public enum MMCV_list { A, B, C }
}
```

MMCC (Meta-Model Class Classification): A property of a MMC that provides a finite classification of instances of the MMC. A typical implementation of a MMCC in the Java or C# language is a property that yields a Boolean value (true or false) or an enumeration value (e.g. RED, GREEN or BLUE).
MMCCV (Meta-Model Class Classification Value): A specific value of a MMCC, e.g. true, false, RED, GREEN, BLUE etc.
MMEC (Meta-Model Equivalence Class): A subset of MMO instances of a MMC that satisfies the same binding of the available MMCCs for the MMC, where each MMCC is either bound to a specific MMCCV or unbound.
   For example if a MMC defines two MMCCs, MMCC1 and MMCC2 where MMCC1 can take the values “true” or “false” and MMCC2 can take the values “RED”, “GREEN” or “BLUE”, a binding for that MMC is “MMCC1=true AND MMCC2=RED”, another binding is “MMCC1=true” (here MMCC2 is left unbound) and a third binding is “MMCC1=false AND MMCC2=GREEN).
MMO (Meta-Model Object; 920): An instance of MMC. The MMC defines the layout of data while the MMO realises a specific set of values according to the MMC layout. There are four main subtypes and the combinations thereof corresponding to the four main subtypes of MMC:
   MMO-Plain: An instance of MMC-Plain.
   MMO-Settable: An instance of MMC-Settable.
   MMO-Identifiable: An instance of MMC-Identifiable.
   MMO-Singleton: An instance of MMC-Singleton.
MOG (Managed Object Graph): A collection of vertices and directed edges where a vertex is a MMO-Identifiable and a directed edge is a MMCON. Comparing the MOG to object graphs (OGs) known to common object-oriented languages such as Java, C# or C++, the MOG is limited to objects of subtype MMO-Identifiable and there may be an arbitrary relationship between the vertices of the MOG and the vertices of the OG, including the case where there is no relationship.
MMCON (Meta-Model Connection): A pair of identifiers (ID1, ID2) for two different MMO-Identifiable objects describing a directed edge in the MOG from the MMO-Identifiable identified by ID1 to the MMO-Identifiable identified by ID2.
TDC (Test Driver Code; 510, 610, 720): User defined code that interacts with the SUT using MOs with Ns for the purpose of exercising, testing and measuring (e.g. for performance or resource usage) the SUT. The TDC consists of TMs, MMCs and additional arbitrary code for arbitrary purposes such as data preparation, data transformation, validation, receiving a call-back or any other arbitrary purpose.
TM (Test Method; 512, 612, 721, 801, 930): User defined code within the TDC that takes 0 or more MMOs as input, emits 0 or more MMOs as TMCO or TMUO, emits 0 or more additions or removals of TMCONs as TMNCON and TMDCON and returns a

TABLE 5
C# examples of TMs (input and TMIO)

```
[TestClass]
public class TDC_Class
{
  [TestMethod]
  public void TM1( ) { CUT.IM1( ); }
  [TestMethod]
  public static void TM2(MMC mmo)
  {
    CUT.IM2(mmo.SomeMo);
  }
  [TestMethod]
  public TMIOC TM3(MMC1 mmo1, MMC2 mmol)
  {
    CUT.IM3(mmol.SomeMo, mmo2.SomeOtherMo);
    return TMIOC.X;
  }
  public enum TMIOC { X, Y, Z };
}
```

TMIO.
TMIOC (Test Method Immediate Outcome Classification): A finite classification used to classify the outcome of a TM, for example the list of values “A”, “B”, “C”.
TMIOCV (Test Method Immediate Outcome Classification Value): A specific value for a TMIOC, for example the value “A”.
TMCO (Test Method Checked Output; 940): An MMO emitted from a TM under the condition that any subsequent invocation of the TM through the same TC must yield another TMCO that belongs to the same MMEC as the current TMCO. The TMCO may be associated with an optional timestamp indicating the earliest point in time when the MMO may be used as argument for another TM.

TABLE 6
C# example of emitting checked MMOs
with and without a timestamp

```
[TestClass]
public class TDC_Class
{
  [TestMethod]
  public void TM(MMC1 mmo1, MMC2 mmo2)
  {
    TestContext.Current.AddChecked(mmo1);
    DateTime when = DateTime.Now + 1;
    TestContext.Current.AddCheckedLater(when, mmo2);
  }
}
```

TMUO (Test Method Unchecked Output; 950): An MMO emitted from a TM without any condition against previous or subsequent TMCOs or TMUOs. The TMUO may be associated with an optional timestamp indicating the earliest point in time when the MMO may be used as argument for another TM.

TABLE 7
C# example of emitting unchecked MMOs
with and without a timestamp

```
[TestClass]
public class TDC_Class
{
  [TestMethod]
  public void TM(MMC1 mmo1, MMC2 mmo2)
  {
    TestContext.Current.AddUnchecked(mmol);
    DateTime when = DateTime.Now + 1;
    TestContext.Current.AddUncheckedLater(when, mmo2);
  }
}
```

TMNCON (Test Method New Connection; 960): A MMCON indicating the establishment of a new edge (MMCON) in the MOG.

TABLE 8
C# example of emitting a TMNCON

```
[TestClass]
public class TDC_Class
{
  [TestMethod]
  public void TM(MMC1 mmo1, MMC2 mmo2)
  {
    TestContext.Current.Connect(mmo1, mmo2);
  }
}
```

TMDCON (Test Method Deleted Connection; 970): A MMCON indicating the deletion of an existing edge (MMCON) in the MOG.

TABLE 9
C# example of emitting a TMDCON

```
[TestClass]
public class TDC_Class
{
  [TestMethod]
  public void TM(MMC1 mmo1, MMC2 mmo2)
  {
    TestContext.Current.Disconnect(mmo1, mmo2);
  }
}
```

TMIO (Test Method Immediate Outcome; 912): The immediate outcome of a test method which can either be empty (void), a fault (for example an exception) or a TMIOCV.
TMEO (Test Method Effective Outcome; 913): The result of a user-defined mapping of a TMIO onto the value list (OK_CHECK, OK_NOCHECK, FAIL, IGNORE).
TR (Test Runner; 710, 910): The program that loads the TDC and executes the TMs within the TDC.
TC (Test Condition; 800): A TC is a data record as illustrated in FIG. 4 that is used by the TR to guide the execution of TMs within the TDC. A TC may be executed in the sense that the information with the TC is used to identify the TM to execute, to prepare the input data (the arguments) for the TM, to map the TMIO of the TM and to capture the TMCO of the TM.

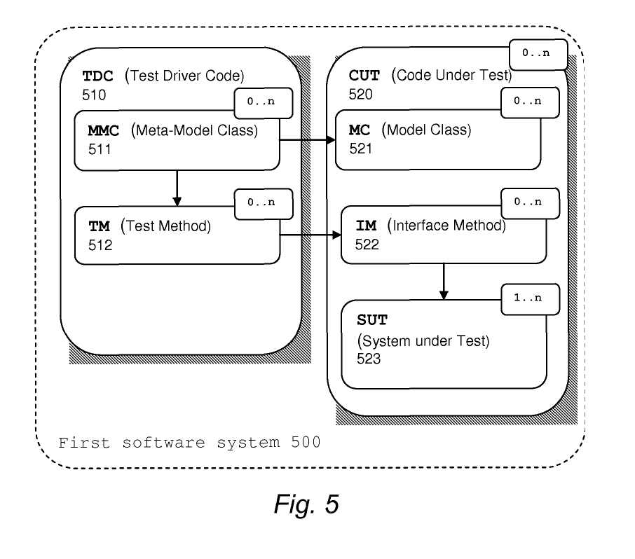

FIG. 5 illustrates a relationship between a System Under Test, SUT 523, a Code Under Test, CUT 520 and a Test Driver Code, TDC 510 in an embodiment where CUT 520 and SUT 523 belong to the same logical code module 520. SUT 523 is accessed through its Interface Methods IM 522 by calling these with Model Objects (MOs) that have been instantiated from Model Classes MC 521 defined in the CUT 520.

A common case is a code library defining types MC 521 and functions and/or methods IM 522 that are called using the aforementioned types.

The TDC 510 defines additional Meta-Model Classes, MMC 511 optionally each referring to 0 or more MCs 521 in the CUT 520, and the TDC 510 defines Test Methods, TM 512 that take 0 or more Meta-Model Objects (MMOs) that have been instantiated from the aforementioned MMCs 511, where the TMs 512 further call 0 or more IMs 522 in the CUT 520.

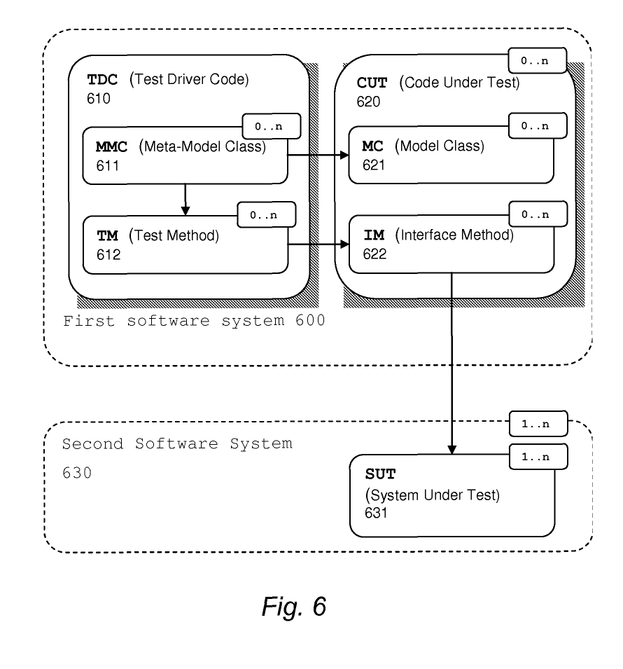

FIG. 6 illustrates an embodiment where the CUT 620 and SUT 631 are detached, for example in the case where CUT 620 is a client-side service library operated on the first software system 600 and where SUT 631 is a server side implementation of the services operated on the second software system 630.

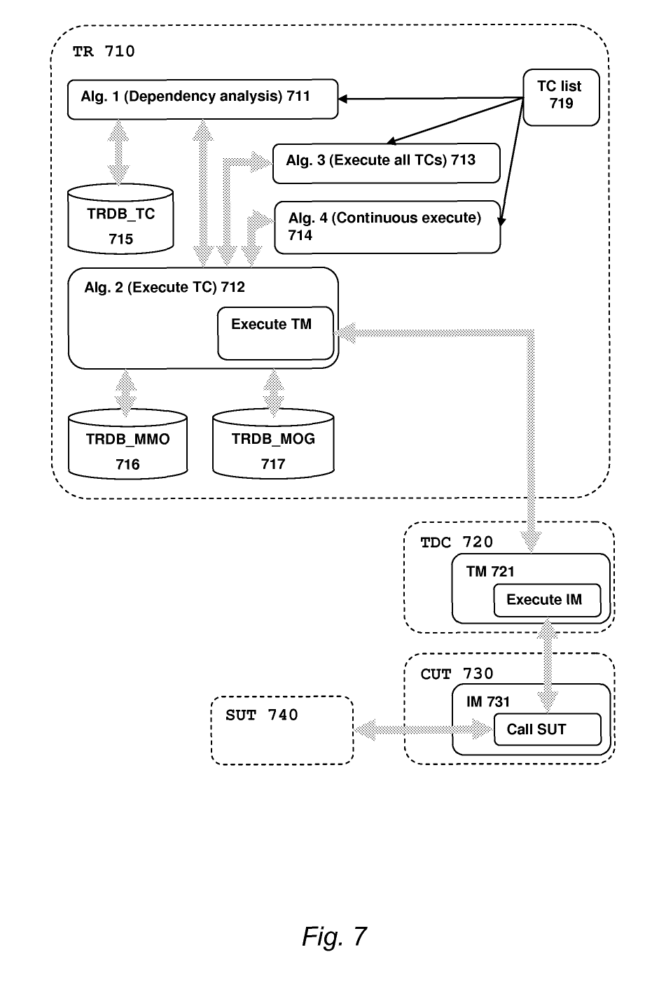

FIG. 7 illustrates how a test runner TR 710 executes Test Methods TM 721 in the TDC 720 that further executes Interface Methods IM 731 in the CUT 730 that further calls the SUT 740 to activate its functionality.

The process starts with a list of Test Conditions TC list 719 that is first passed to algorithm 1 711. Algorithm 1 711 performs a dependency analysis that associates with all TCs in TC list 719 a rank. Algorithm 1 711, further detailed below, uses a database containing test conditions TCs, TRDB_TC 715, in a lookup that determines when a TC is enabled, and it uses algorithm 2 712, further detailed below, to execute unranked TCs and updates TRDB_TC 715 according to a test method checked output, TMCO, that is emitted during the execution of the TC.

Algorithm 2 712 uses a database containing meta-model objects, TRDB_MMO 716, to retrieve meta-model objects, MMOs, to use as arguments for executing TMs, and for storing MMOs in the TMCO and test method unchecked output, TMUO, that is emitted during execution of the TC.

Algorithm 2 712 further uses a database containing managed object graphs, TRDB_MOG 717, in a retrieval of a transitive closure rooted in the arguments passed to the executed TC, and for storing changes to the managed object graph, MOG, using the information in TMCO, TMUO, test method new connection (TMNCON) and test method deleted connection, TMDCON, that is emitted during the execution of the TC.

Algorithm 3 713, further detailed below, uses algorithm 2 712 to execute each TC in the TC list 719 at least once.

Algorithm 4 714, further detailed below, uses algorithm 2 712 to execute the TC in the TC list 719 continuously according to a probability distribution.

### Algorithm 1A—Dependency Analysis

The goal of the first algorithm is to obtain observed output on a sufficient number of TCs that all available TCs can be executed by the second algorithm or, if not all TCs can be executed; those that cannot be executed can be identified after the first algorithm has complete on the available TCs.

More precisely, the goal of this algorithm is to record observed output of a sufficient number of TCs such that for any available TC it is either possible to devise a sequence of other TCs such that the execution of these other TCs according to algorithm 2 yields MMOs in the TRDB_MMO that fulfils the complete input specification of the selected TC, or such that it can reliably be decided that it is impossible to yield MMOs in the TRDB_MMO that fulfils the complete input specification of the selected TC, and hence that the selected TC cannot be executed.

Definition of a TC being “enabled”: A TC is enabled if is not known to fail and if it's input specification is empty or if for each MMEC in the input specification it is true that either:
a) The related MMC of the MMEC is of subtype MMC-Settable, OR
b) The related MMC of the MMEC is indexed in TRDB_TC, OR

### Preconditions

Pa: A variable “current rank” is initialized to the value 0.
Pb: All available TCs are placed in an enumerable list “UL” of unranked TCs, each TC having its Rank reset to a default value, for example to the value −1.
Pc: TRDB_TC is cleared.

### Algorithm

1. All TCs in UL that are enabled are deleted from UL and added to the list “CL” of TCs with the current rank.
2. If CL is empty then all TCs still left in UL are marked as unable to run and the algorithm terminates.
3. All TCs in CL have the value of the “current rank” variable assigned to the TC's Rank value.
4. [optional step] If UL is empty then the algorithm terminates.
5. Any TC in CL that has not previously been executed and had its observed output set, is executed using algorithm 2 below
6. All TCs in CL are added to TRDB_TC and indexed according to the TC's priority, according to the TC's rank and according to each MMEC in the TC's observed output.
7. CL is cleared.
8. The “current rank” variable is incremented by one.
9. The process is repeated from step 1.

The result of the dependency analysis can be used to guide the execution of the set of test conditions using the following algorithm that determines how a test condition can have data generated for its input parameters before the test condition is executed: This achieves the first and the third object of the invention.

### Algorithm 2A—Execution of a Test Condition

The goal of this algorithm is to prepare a list of MMOs belonging to the MMECs listed in the selected TC's input specification, subsequently to execute the TM of the TC, subsequently to collect and process TMIO, TMCO, TMUO, TMNCON and TMDCON.

### Preconditions

Pa: The selected TC must have been assigned a non-default rank of value 0 or greater.
Pb: Using Algorithm 1A, TRDB_TC must be initialized up to the rank at least one lower than the rank of the selected TC. Alternatively, if the selected TC has a rank of 0 the TRDB_TC may be empty.
Pc: The selected TC must be enabled.

### Algorithm

1. Initialization of variables:
   A variable “ARGS” capable of containing a list of MMOs is initialized to the empty list.
   A variable “TCLOS” capable of containing a MOG is initialized to the empty MOG and added to TRDB_BUSY_MOG.
   A variable “MMEC_UNBOUND” capable of holding 0 or 1 MMEC is initialized to hold no MMEC.
   A variable “ReleaseTime” capable of containing a timestamp is initialized to the current time.
2. For each MMEC in the TC's input specification for which there has not yet been acquired a MMO that belongs to that MMEC, the TRDB_MMO is searched for a MMO belonging to the MMEC. If the search is successful and the MMO2 resulting from the search is of subtype MMO-Identifiable then step a below is taken, else if the search is successful and the result is captured in MMO2 then step b below is taken, else step c below is taken:
   a. The transitive closure C originating in MMO2 in the TRDB_MOG is computed. If C overlaps with any MOG other than TCLOS in TRDB_BUSY_MOG then the algorithm proceeds from step c below else the below steps are taken:
      C is added to TCLOS.
      MMO2 is removed from the TRDB_MMO.
      All MMOs in C are removed from TRDB_MMO.
      MMO2 is added to ARGS.
      If the TRDB_MMO had a timestamp “TS” associated with MMO2 and TS is later than the variable ReleaseTime, then the variable ReleaseTime is assigned the value of TS.
      The algorithm proceeds to search the next MMEC in the TC's input specification.
      Remark: A transitive closure originating in a root vertex in a directed graph such as the MOG is another directed graph comprised of all vertices and all edges reachable from the root vertex by traversing edges along their direction. Observe that if the directed graph is a MOG then the transitive closure is also a MOG.
   b. * If MMO2 is not a MMO-Singleton then MMO2 is removed from the TRDB_MMO.
      MMO2 is added to ARGS.
      If the TRDB_MMO had a timestamp “TS” associated with MMO2 and TS is later than the variable ReleaseTime, then the variable ReleaseTime is assigned the value of TS.
      The algorithm proceeds to search the next MMEC in the TC's input specification.
   c. * All MMOs in ARGS that are not of subtype MMO-Singleton are added to TRDB_MMO together with the optional timestamp that was associated with the MMO when found in TRDB_MMO.
      ARGS is cleared,
      TCLOS is added to TRDB_MOG.
      All MMOs in TCLOS are added to TRDB_MMO together with the optional timestamp that was associated with the MMO when found in TRDB_MMO.
      TCLOS is cleared,
      MMEC_UNBOUND is assigned the current MMEC.
      ReleaseTime is set to the current time.
      The algorithm proceeds to step 3.
   d. [alternative to step c] MMEC_UNBOUND is assigned the current MMEC and the algorithm proceeds to step 3
3. If MMEC_UNBOUND does not contain a MMEC then the algorithm proceeds to step 4, else the TRDB_TC is searched for the TC of highest priority then the lowest rank that is keyed by the value of MMEC_UNBOUND. This TC is named TC2.
   TC2 is executed as selected TC using algorithm 2A.
   The algorithm proceeds to step 2.
   Remark: TC2 above must exist because of preconditions Pa,Pb and Pc.
4. The algorithm waits until the current time is later than ReleaseTime.
5. The TM of the selected TC is executed using the MMOs in ARGS as arguments and TMIO, TMCO, TMUO, TMNCON and TMDCON is collected.
6. TMIO is mapped to TMEO using the outcome mapping of the TO.
7. One of the below actions is taken depending on the value of TMEO:
   OK_CHECK: The algorithm continues from step 8.
   OK_NOCHECK: The algorithm continues from step 9.
   FAIL: The algorithm continues from step 10.
   IGNORE: The algorithm continues from step 11.
8. A new set of MMECs is created and stored in a new variable e.g. a variable named “OBS”. For each MMO in TMCO the MMEC of the MMO is found and added to OBS ignoring duplicates.
   If the observed output of the selected TC has not been set then the observed output is assigned the value of OBS, else if OBS and the observed output of the TC are identical then the algorithm continues from step 12 else the algorithm continues from step 10.
9. All MMOs in TMCO are added to TMUO, TMCO is cleared and the algorithm continues from step 12.
10. TMCO, TMUO, TMNCON and TMDCON are cleared and the TR is signaled that the execution of the selected TC has failed. The algorithm continues from step 12.
11. All MMOs in TMCO are added to TMUO, TMCO is cleared, the TR is notified that the execution of the selected TC must be ignored, for example such as to repeat step 5 of algorithm 1A for the selected TC. The algorithm continues from step 12.
12. This step involves the following sub steps:
   a. All MMOs of subtype MMO-Identifiable in TMCO and TMUO are added as vertexes to the TRDB_MOG if not already present in the TRDB_MOG.
   b. All MMCONs in TMNCON are added as edges to the TRDB_MOG if not already present in the TRDB_MO. All MMCONs in TMDCON are removed from the edge list in TRDB_MOG.
   c. All MMO-Identifiables in TCLOS that do not appear in either TMCO or TMUO are collected in a new set “PR” (Potentially Removed) and any MMO-Identifiables in PR that cannot be reached from any vertex in the TRDB_MOG excluding the vertices in PR is removed from the TRDBMOG and from the TRDB_MMO and from PR and all edges originating from a removed vertex is also removed from the MOG.
   d. All remaining vertices in PR are added to TRDB_MMO together with the optional timestamp that was associated with the MMO before the MMO was last removed from the TRDB_MMO.
   e. All MMOs in TMCO and TMUO are added to the TRDB_MMO together with any timestamp associated with the MMO in TMCO or TMUO.
   f. TCLOS is removed from TRDB_BUSY_MOG.
   g. If the TMEO has FAIL or IGNORE then the algorithm terminates.
   h. If the algorithm has been recursively called from itself then InvocationCount2 of the TC is incremented by one, else InvocationCount1 of the TC is incremented by one.

Using algorithms 1A and 2A, meta-model-objects emitted as output or second output during execution of earlier test conditions are reused as parameter values for the currently executing test condition, and if a meta-model-object for parameter cannot be found, a second test condition known to output the meta-model-object that could not be found, is found and executed. This achieves the sixth object of the invention.

The execution of TCs may happen in parallel (i.e. concurrently) by executing one instance of algorithm 2A for each parallel execution of a TC. Further, the execution of algorithm 1A may utilize parallelism in its step 5 by parallelize the execution of TCs in its variable CL in that step.

This achieves the seventh object of the invention.

The update of InvocationCount1 and InvocationCount2 enables the achievement of the fourth and fifth object of the invention using algorithm 3A and 4A respectively.

Through the use of a MOG and through steps 2a, 2c and 12a-d of algorithm 2A it is ensured that the entire transitive closure of all arguments to the TM of the TC has been exclusively granted to the execution of the current TC only, and that any change to any MMO in the above transitive closure that results in the MMO belonging to a new set of MMECs is accurately reflected in the TRDB_MMO.

This achieves the nineth object of the invention.

As an effect of step 4 in algorithm 2A the execution of a TC is delayed until the optional timestamps of all MMOs used as arguments for the TM of the TO have expired.

This achieves the eighth object of the invention.

### Variations of Algorithm 2A

Variation 1: In an embodiment that does not implement MMC-Identifiable, algorithm 2A will proceed as if TRDB_MOG, TRDB_BUSY_MOG, TCLOS, TMNCON and TMDCON are always empty.

Variation 2: Step 2d may substitute step 2c either:
always,
randomly, or
according to a selection criteria, for example in step 2 alternating between step 2c and 2d on a per-MMEC basis, for example using step 2d as the preferred step but reverting to step 2d if, for example TC2 in step 3, directly or recursively, does not satisfy precondition Pc.

Variation 3: An embodiment may choose not to require precondition Pa.

Instead, if precondition Pa is not satisfied algorithm 2A can for example execute a variation of algorithm 1A that terminates immediately when precondition Pa becomes satisfied for the selected TC.

Variation 4: An embodiment may in step 5 pause a variable amount of time either before or after the execution of the selected TC, to control the rate at which TCs are executed.

There is a plurality of methods to select test conditions and schedule them for execution, for example, “Every Condition Once” and “Probability Distribution” as described below.

### Algorithm 3A—Every Test Condition Once

The goal of this algorithm is to execute every available TC at least once.

### Preconditions

Pa: A list of TCs which have been selected for execution.
Pb: The list of selected TCs has been analyzed according to algorithm 1A.
Pc: Each TC in the list of selected TCs has been assigned a rank greater than or equal to 0.
Pd: Each TC in the list of selected TCs has its InvocationCount1 and InvocationCount2 set to 0.

### Algorithm

1. For each TC in the list of selected TCs, if the sum of InvocationCount1 and InvocationCount2 is 0 the condition is executed using algorithm 2A.

Together with algorithm 2A, this algorithm achieves the fourth object of the invention.

### Algorithm 4A—Probability Distribution

The goal of this algorithm is to continuously execute a plurality of TCs according to a probability distribution until some stopping criteria is satisfied. When the algorithm terminates, the sum of InvocationCount1 and InvocationCount2 for each TC in the plurality of TCs is the number of times each respective TC has been executed.

### Preconditions

Pa: A list of TCs which have been selected for execution.
Pb: The list of selected TCs has been analyzed according to Algorithm 1A.
Pc: Each TC in the list of selected TCs has been assigned a rank greater than or equal to 0.
Pd: Each TC in the list of selected TCs has its InvocationCount1 and InvocationCount2 set to 0.
Pe: Each TC in the list of selected TCs has been assigned a target probability between 0 and 1.
Pf: The sum of the target probabilities of all the TCs selected for execution is 1.

### Algorithm

1. If the stopping criterion, for example a time limit or an iteration count limit, is satisfied, the algorithm terminates.
2. A first TC “TC1” is chosen at random according to the probability distribution.
3. If InvocationCount2 of TC1 is greater than 0 then InvocationCount2 is decremented by 1 and InvocationCount1 of TC1 is incremented by 1, else TC1 is executed using algorithm 2A.
4. The algorithm continues from step 1.

Together with algorithm 2A, this algorithm achieves the fifth object of the invention.

The second object of the invention may for example be achieved by providing a compact language for defining a multitude of input specifications 802 and for each input specification in the multitude of input specifications, creating a TC 800 by applying the same 801 TM, the same 803 outcome mapping, the same 805 priority, the same 807 target probability and default values for 804 observed output, 806 rank, 808 IncovationCount1 and 809 InvocationCount2. In an embodiment, Backus-Naur-Form (BNF) may be utilized as syntax in order to specify the syntax of a TC generating language. For example, a list of test conditions may be generated using an expression language such as the language illustrated in Table 10.

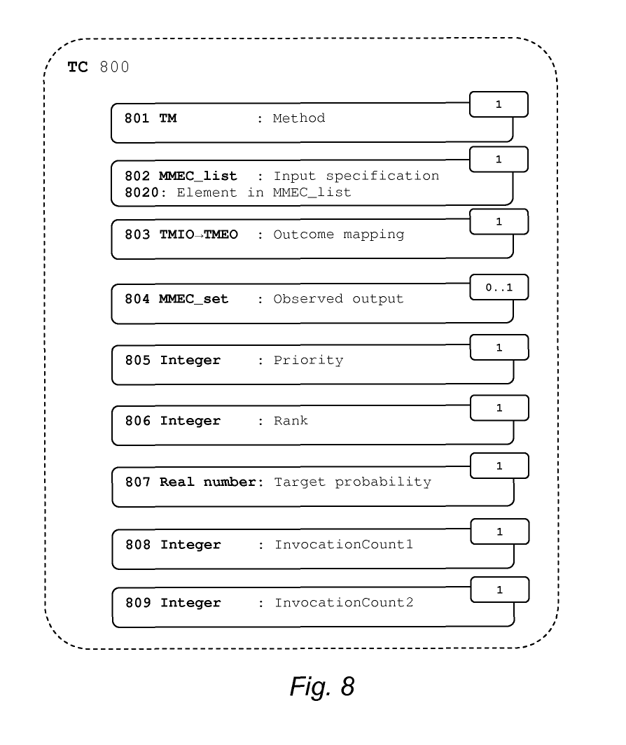

FIG. 8 illustrates a number of components contained in a test condition TC 800:
801 Method: The test method to invoke.
802 Input specification: For each parameter to the method, the equivalence class to which it must belong. 8020 represents an element in the MMEC_list.
803 Outcome mapping: Mapping from test method immediate outcome, TMIO, to test method effective outcome, TMEO.
804 Observed output: Recording of the TMCOs emitted during the last successful invocation of the TC. The observed output is a set that excludes duplicates.
805 Priority: Used during execution to choose between TCs.
806 Rank: Used in the dependency analysis of algorithm 1A (711) to determine the topology of the TCs.
807 Target probability: User-defined probability between 0 and 1 of the TC being executed. The sum of the target probabilities across all TCs must be 1.
808 IncovationCount1: Used when continuously executing TCs according to a probability distribution.
809 IncovationCount2: Used when continuously executing TCs according to a probability distribution.

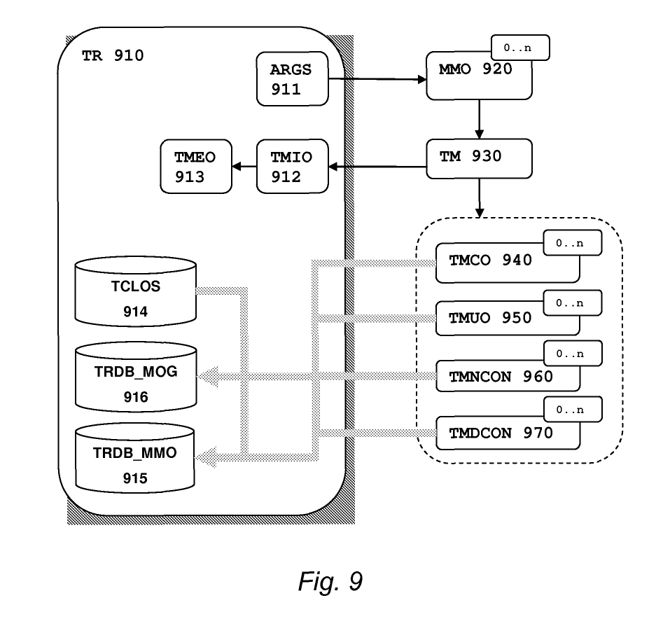

FIG. 9 illustrates the details of the test runner TR (710, 910) executing a TM 930 identified by TM 801 in a TC 800 (see FIG. 8):

Step 1: The TR 910 prepares arguments, ARGS 911, as a list of 0 or more MMOs 920 to serve as arguments when invoking the TM 930. The TR 910 uses the information available in input specification MMEC_list 802 in a TC 800 (see FIG. 8) to determine the number and meta-model equivalence class, MMEC, of each of the MMOs 920 in ARGS 911.

Step 2: The TR 910 executes the TM 930.

Step 3: During the course of execution, the TM 930 emits zero or more of each of the following: Meta-Model Checked Output MMCO 940, Meta-Model Unchecked Output MMUO 950, Meta-Model New Connection MMNCON 960 and Meta-Model Deleted Connection MMDCON 970.

Step 4: When the execution of TM 930 completes, all emitted data (940, 950, 960, 970) is returned to the TR 910 together with the TM Immediate Output TMIO 912.

Step 5: The TMIO 912 is mapped to TMEO 913 using the TMIO→TMEO mapping 803 of TC 800 of FIG. 8.

Step 6: Depending on the value of TMEO 912, the TR proceeds according to algorithm 2A and updates TRDB_MOG 916 and TRDB_MMO 915 with the data stored in transitive closure TCLOS 914, TMCO 940, TMUO 950, TMNCON 960 and TMDCON 970.

In an embodiment, the data structures and code described above are typically stored on a computer-readable storage medium, which may be any device or medium that can store code and/or data for use by a computer system. This includes, but is not limited to, magnetic and optical storage devices such as disk drives, magnetic tape, CDs (Compact Discs) and DVDs (digital versatile discs or digital video discs), and computer instruction signals embodied in a transition medium (with or without a carrier wave upon which the signals are modulated). For example, the transmission medium may include a communications network, such as the Internet

Further, the TR, TM, TDC, CUT, IM, SUT, and the algorithms can be executed on a computer as shown in FIG. 2.

The SUT and the CUT define the subject of the test and are considered as givens.

The TDC may be defined within the CUT or may be defined separately from the CUT or both, to provide the TR with MMCs and TMs.

The TR is prepared once as separate program code that is able to load and run arbitrary TDCs.

During initialization of the TR, the TR must obtain knowledge of available TMs and MMCs in the TDC. In one embodiment the TR loads the TDC and inspects the types defined within it using reflection as e.g. known in the programming languages of e.g. Java and C#, to identify TMs and MMCs. In another embodiment this information is passed to the TR separately.

During initialization of the TR, the TR must further obtain definitions of TCs. In one embodiment a TC is defined manually by for a TM defining the input specification (see FIG. 8), the outcome mapping and optionally the target probability. In a manual definition process, multiple input specifications may be derived from a single condition generating expression according to, for example, the expression syntax illustrated in Table 10 where each input specification automatically defines a new TC for the TM.

In a further embodiment a TC is read from a predefined list of TC specifications which for each TC implicitly or explicitly sets the input specification and/or the outcome mapping and/or the target probability.

In a third embodiment the definition of a TC, for example the target probability or the outcome mapping, may be set and/or changed by the TR itself, before, during or after execution of the available TC.

The TR maintains a database of MMOs (TRDB_MMO) and indexes each MMO by the 1 or more MMECs it belongs to, and associates with each MMO an optional timestamp indicating the point in time when the MMO at the earliest may be used as argument for a TM. In one embodiment TRDB_MMO is initialized to the empty database and in another embodiment TRDB_MMO is initialized to a predefined content. When a MMO is added to the database it is automatically indexed according to the MMECs it belongs to. The MMECs are determined by inspecting the type (MMC) of the MMO and by inspecting the MMCCs of the MMO. If a MMO belongs to no MMEC it is not indexed.

The TR further maintains a separate database of TCs (TRDB_TC) and indexes each TC by the TC's priority, by the TC's rank and by each of the MMECs occurring in the TCs observed output list. If a TC has no observed output it is not indexed.

The TR further maintains a MOG in TRDB_MOG and a collection of MOGs in a database TRDB_BUSY_MOG.

The priority of a TC may be set or changed manually or automatically, at any point in time before, during or after the TR is executing the available TCs.

After the TR has been initialised the first time with one or more TDCs and one or more definitions of TCs, the database TRDB_TC is empty because no TCs have been executed, hence no TC as an observed output defined, hence no TC is indexed and the database TRDB_TC is empty.

The foregoing descriptions of embodiments of the invention have been presented for the purpose of illustration and description only. They are not intended to be exhaustive or to limit the invention to the forms disclosed. Accordingly, many modifications and variations will be apparent to the practitioners skilled in the art. Additionally, the above disclosure is not intended to limit the invention. The scope of the invention is defined by the appended claims.

In general, any of the technical features and/or embodiments described above and/or below may be combined into one embodiment. Alternatively or additionally any of the technical features and/or embodiments described above and/or below may be in separate embodiments. Alternatively or additionally any of the technical features and/or embodiments described above and/or below may be combined with any number of other technical features and/or embodiments described above and/or below to yield any number of embodiments.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A method of automatic testing of at least one system under test accessed through at least one interface method defined in a code under test which is accessed via at least one test method defined in a test driver code which is accessed via a test runner; wherein the test runner comprises a list of test conditions, a dependency analysis algorithm and an algorithm for preparing and executing a single test condition, wherein the method comprises:
defining in the test driver code at least one data type defining at least one classification of the data type onto a first finite set of classes;
defining in the test driver code at least one test method, wherein at least one of the at least one test method requires at least one parameter of the data type, and wherein each of the test methods produces an outcome, which can be classified onto a second finite set of classes, and wherein at least one test method produces at least one output of the data type;
defining in the test runner a list of test conditions, wherein each test condition identifies one test method, and for each parameter in the test method, the test condition specifies one equivalence class, and wherein each test condition defines the classification (803) of the test method's outcome onto the second finite set of classes (TMEO 913) containing at least a success value and a fail value (FAIL);
executing in the test runner a test method according to a test condition, wherein each parameter value in the test method belongs to the equivalence class specified for the parameter in the test condition (TC 800);
during execution of the test method, the test runner records the at least one output from the test method;
after execution of the test method, the test runner records the test method's outcome and performs the classification (803) of the test method's outcome onto the second finite set of classes specified in the test condition (TC 800) to produce a value contained in the second finite set of classes; “if the value does not indicate a failure, then determining an equivalence class to which the at least one output recorded by the test runner belongs and indexing the at least one output in a first database of the test runner according to the at least one equivalence class to which the output belongs;
if the value indicates a success, then determining an equivalence class to which the at least one output recorded by the test runner belongs and recording the equivalence class in an observed output of the test condition.

2. A method according to claim 1, wherein the code under test comprises at least one component, wherein a component is either contained in the system under test or identical to the system under test or disjoint from the system under test.

3. A method according to claim 1, wherein the test driver code comprises at least one component, wherein a component is either contained in the code under test or identical to the code under test or disjoint from the code under test (CUT 520, 620, 730),

4. A method according to claim 1, wherein the data type comprises at least one of:
1. an identifier providing unique identification of different instances of the data type; and
2. a method of instantiating the data type such that it belongs to an equivalence class applicable to that data type; and
3. a marker applying to any instance of that data type.

5. A method according to claim 1, wherein at least one test method produces at least one second output of the data type.

6. A method according to claim 4, wherein a test condition is identified as enabled if it does not take any parameters or if for each meta-model-equivalence-class in an input specification of the test condition it is true that either the meta-model-class (MMC) associated with the meta-model-equivalence-class is identified as MMC-Settable or the meta-model-equivalence-class is indexed in a second database (TRDB_TC 715).

7. A method according to claim 6, wherein the method further comprises:
1. Initializing a “current rank” variable to the value 0;
2. Storing all test conditions in an enumerable list “UL” containing unranked test conditions and wherein each test condition having its rank reset to a default value;
3. Initializing a “CL” variable capable of containing test conditions;
4. Clearing the second database;
5. Repeating until the method terminates: a. Clearing the CL variable; b. deleting test conditions identified as enabled from the enumerable list and adding them to the “CL” variable; c. If the CL variable is empty then marking all test conditions in the UL list as unable to run and terminating the method; d. assigning the value of the current rank variable to the rank of each test condition in the CL variable; e. If the UL list is empty then terminating the method; f. executing any test condition in the CL list which has not had its observed output (804) set; g. adding all test conditions in the CL list to the second database, indexing each test condition by the rank of the test condition and by each meta-model-equivalence-class in the observed output; h. incrementing the “current rank” variable by one.

8. A method according to claim 7, wherein the method further comprises:
1. If a test condition has a rank value of default value then terminating the method; 2. For each test condition initializing the value of InvocationCount1 of the test condition (800) to 0, and initializing the value of InvocationCount2 of the test condition to 0; 3. For each test condition; if the sum of invocationCount1 and InvocationCount2 (809) is 0 then executing the test condition (TC 800).

9. A method according to claim 7, wherein the method comprises:
1. If a test condition has a rank value (806) of default value then terminating the method;
2. If a test condition has a target probability value greater than 1 or less than 0 then terminating the method;
3. If the sum of the target probability value of all test conditions is not 1 then terminating the method; 4. LÎ For each test condition initializing the value of invocationCount1 to 0; and initializing the value of InvocationCount2 to 0.
5. Terminating the method if a stopping criterion is satisfied, the stopping criterion comprising one of; a. a time limit, or b. an iteration count limit;
6. A first test condition is chosen at random according to the probability distribution;
7. If InvocationCount2 of the first test condition is greater than 0, then decrementing by 1 InvocationCount2 and incrementing by 1 InvocationCount1, else executing the first test condition;
8. The method proceeds from [L1];

10. A method according to claim 7, wherein the executing of a first test condition comprises a second algorithm comprising:
1. If the first test condition has a rank of value less than 0 then terminating the method;
2. If the second database has not been initialized up to a rank value at least one lower than the rank of the first test condition and the first test condition does not have a rank of zero, then terminating the method;
3. If first test condition is not enabled, then terminating the method;
4. Initializing an “ARGS” variable capable of containing a list of meta-model-objects to an empty list; 5. Initializing a “MMEC_UNBOUND” variable capable of containing zero or one meta-model-equivalence-class to contain zero meta-model-equivalence-class,
6. LO: For each meta-model-equivalence-class in the input specification (802) of the first test condition for which there has not been acquired a meta-model-object belonging to the meta-model-equivalence-class, the first database is searched for a meta-model-object belonging to the meta-model-equivalence-class; storing the zero or one resulting meta-model-objects in a “MMO2” variable; if the MM02 variable is not empty then performing step 6a, else performing step 6b;
Step 6a; 1. removing the MM02 variable from the first database; 2. adding the MM02 variable to the ARGS variable;
Step 6b: 1. adding to the first database all meta-model-objects in the ARGS variable;
2. clearing the ARGS variable,
3. adding the current meta-model-equivalence-class to the MMECJJNBOUND variable; 4. proceeding to step [L1];
7. L1: If MMEC_UNBOUND does not contain a MMEC then proceeding to step [L2], else the second database is searched for the test condition of a rank lower than the rank of the first test condition that is keyed by the value of MMEC_UNBOUND resulting in a second test condition (TC2);
8. recursively executing the second test condition TC2 in the second algorithm wherein the second test condition takes the place of the first test condition;
9. proceeding to step [LO];
1Q. L2: executing the test method of the first test condition using the meta-model-objects in the ARGS variable as arguments and collecting test method immediate output and test method checked output values; 11. classifying the test method's outcome into TMEO using the outcome mapping of the first test condition. 12. if TMEO is equal to OK then proceeding to step [L3] else if TMEO is equal to FAIL, then proceeding to step [L4];
13. L3: creating a new set of meta-model-equivalence-classes and storing the new set of meta-model-equivalence-classes MMECs in a new variable OBS; For each meta-model-object in the output, the meta-model-equivalence-class MMEC of the meta-model-object MMO is found and added to the new variable OBS; assigning the new variable OBS to the observed output (804) of the first test condition (800); storing all meta-model-objects in the first database; continuing from [L5];
14. L4: clearing output and signaling the test runner that the execution of the first test condition has failed; and terminating the method;
15. L5: if the algorithm has been recursively called from itself then incrementing by one InvocationCount2 of the first test condition, else incrementing by one InvocationCount1 of the first test condition.

11. A method according to claim 10 wherein if TMEO is equal to OK then for each meta-model-object in the second output, the meta-model-object is added to MMO is added to the first database.

12. A method according to claim 1, wherein the output and/or the second output contains a timestamp indicating a point in time from which the output and/or the second output is valid for use as a parameter value for a test method.

13. A method according to claim 10, wherein the output and/or the second output contains a timestamp indicating a point in time from which the output and/or the second output is valid for use as a parameter value for a test method and wherein the method further comprises;
If the “ARGS” variable contains at least one timestamp then delaying the execution of the test method of the first test condition until the time has passed all of the at least one timestamps.

14. A method according to claim 4, wherein the method further comprises organizing a number of identifiers in a managed object graph (MOG) stored in a third database, wherein the managed object graph comprises a collection of vertices and directed edges, and wherein a vertex is an identifier and a directed edge is an ordered pair of vertices.

15. A method according to claim 14, wherein a new directed edge is recorded as a third output, when the test method is executed and wherein a deletion of a directed edge is recorded as a fourth output, when the test method is executed,

16. A method according to claim 10, wherein the method further comprises organizing a number of identifiers in a managed object graph (MOG) stored in a third database, wherein the managed object graph comprises a collection of vertices and directed edges, and wherein a vertex is an identifier and a directed edge is an ordered pair of vertices and wherein a new directed edge is recorded as a third output, when the test method is executed and wherein a deletion of a directed edge is recorded as a fourth output (TMDCON 970), when the test method is executed; and wherein prior to the execution of the test method, a transitive closure has been computed from the third database using the identifiers of the parameter values as roots for the computation; removing from the first database the meta-model-objects (MMO) identified by the vertices in the transitive closure; after the execution of the test method and if the value indicates a success (OK), then each third output is added to the third database, and each fourth output is removed from the third database, and if the transitive closure is not empty, each data type instance (MMO) identified in the transitive closure and reachable from any meta-model object (MMO) in the first database (TRDB_MMO 716, 915) through the third database is added to the first database.

17. A method according to claim 10 wherein a plurality of test conditions is executed simultaneously.

18. A device for automatic testing of at least one system under test (SUT 523, 631, 740), wherein the device is adapted to execute the method according to claim 1.

19. A computer readable medium having stored thereon instructions for causing one or more processing units to execute the method according to claim 1.

20. A computer program product comprising program code means adapted to perform the method according to claim 1, when said program code means are executed on one or more processing units.
